(19) United States
(12) Patent Application Publication
(10) Pub. No.: US 2025/0286573 A1
(43) Pub. Date: Sep. 11, 2025

(54) COMMUNICATIONS DEVICE WITH BROADBAND TRANSPORT AND RELATED METHODS

(71) Applicant: Aegis Terra LLC., Sheridan, WY (US)

(72) Inventors: STEPHAN MERLICS, NICEVILLE, FL (US); MARK MITCHELL-HUDDLE, VIRGINIA BEACH, VA (US); MATTHEW AXELSON, VIRGINIA BEACH, VA (US)

(21) Appl. No.: 19/072,887

(22) Filed: Mar. 6, 2025

Related U.S. Application Data
(60) Provisional application No. 63/561,875, filed on Mar. 6, 2024.

(51) Int. Cl. H04B 1/3827; H04B 1/00; H04L 45/85; H04W 4/029; H04W 84/12

(52) U.S. Cl. CPC H04B 1/3833; H04B 1/0057; H04L 45/85; H04W 4/029; H04W 84/12

(57) ABSTRACT

A communications device includes a portable housing, a cellular transceiver carried by the portable housing and configured to connect with an external cellular network, a WLAN transceiver carried by the portable housing and configured to connect with a local wireless device, and a geolocation receiver carried by the portable housing and configured to generate geolocation data. The communications device also includes RF antennas coupled to the cellular transceiver, the WLAN transceiver, and the geolocation receiver, a wired port carried by the portable housing, and a processor carried by the portable housing. The processor is configured to route communications from the wireless device to the external cellular network.

### RELATED APPLICATION

This application is based upon prior filed copending Application No. 63/561,875 filed Mar. 6, 2024, the entire subject matter of which is incorporated herein by reference in its entirety.

### TECHNICAL FIELD

The present disclosure relates to the field of communications, and, more particularly, to a communications device and related methods.

### BACKGROUND

Mobile communications devices have become an integral part of society over the last two decades. Indeed, more than eighty-two percent of Americans own a mobile communications device, for example, a cell phone. The typical mobile communications device includes an antenna, and a transceiver coupled to the antenna. The transceiver and the antenna cooperate to transmit and receive communication signals. In some applications, communications devices with proprietary waveforms are deployed, so called software radios. Due to the nature of these devices, they are limited to geographic areas with compatible infrastructure.

### SUMMARY

Generally, a communications device comprises a portable housing, a cellular transceiver carried by the portable housing and configured to connect with an external cellular network, a wireless local area network (WLAN) transceiver carried by the portable housing and configured to connect with at least one local wireless device, and a geolocation receiver carried by the portable housing and configured to generate geolocation data. The communications device also includes a plurality of radio frequency (RF) antennas coupled to the cellular transceiver, the WLAN transceiver, and the geolocation receiver, at least one wired port carried by the portable housing, and a processor carried by the portable housing and coupled to the cellular transceiver, the WLAN transceiver, the geolocation receiver, and the at least one wired port. The processor is configured to route communications from the at least one local wireless device to the external cellular network.

More specifically, the communications device may also include an RF diplexer coupled between the plurality of RF antennas and the cellular transceiver, the WLAN transceiver, and the geolocation receiver.

Another aspect is directed to a method for operating a communications device comprising a portable housing, a cellular transceiver carried by the portable housing and configured to connect with an external cellular network, and a WLAN transceiver carried by the portable housing and configured to connect with at least one local wireless device. The communications device also includes a geolocation receiver carried by the portable housing and configured to generate geolocation data, a plurality of RF antennas coupled to the cellular transceiver, the WLAN transceiver, and the geolocation receiver, and at least one wired port carried by the portable housing. The method comprises operating a processor coupled to the cellular transceiver, the WLAN transceiver, the geolocation receiver, and the at least one wired port. The processor is configured to route communications from the at least one local wireless device to the external cellular network.

### BRIEF DESCRIPTION OF THE DRAWINGS

FIG. 1 is a schematic diagram of a communication system, according to the present disclosure.

FIG. 2 is a circuit diagram of an ethernet controller in an example embodiment of the communications device, according to the present disclosure.

FIG. 3 is a circuit diagram of an oscillator circuit in an example embodiment of the communications device, according to the present disclosure.

FIG. 4 is a circuit diagram of a power circuit in an example embodiment of the communications device, according to the present disclosure.

FIG. 5 is a circuit diagram of a flash memory circuit in an example embodiment of the communications device, according to the present disclosure.

FIG. 6 is a circuit diagram of a reset circuit in an example embodiment of the communications device, according to the present disclosure.

FIG. 7 is a circuit diagram of an external wake-up circuit in an example embodiment of the communications device, according to the present disclosure.

FIG. 8 is a circuit diagram of an ethernet circuit in an example embodiment of the communications device, according to the present disclosure.

FIG. 9 is a circuit diagram of a USB/power circuit in an example embodiment of the communications device, according to the present disclosure.

FIGS. 10-11 are circuit diagrams of an RF diplexer in an example embodiment of the communications device, according to the present disclosure.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

With software defined radio, there can be a problem due to the lack of interoperability with existing widely deployed networks. In remote areas, this issue can be exacerbated. The present disclosure provides an approach to this issue with a Field Broadband Transport (FBT) device. In short, the FBT device provides a conduit between software defined radios and typical wide spread networks.

In particular, the FBT device may provide a small form factor, ruggedized, body-worn device that provides long-range WiFi, LTE and WLAN/wired connectivity to any edge computing device, Field Compute Device-Wearable (FCD-W) configuration or Manet radio network. Further, single or multiuser connectivity for Line-of-Sight (LoS) local networks may provide users with the ability to transmit and receive vital data from the far-flung deployment areas.

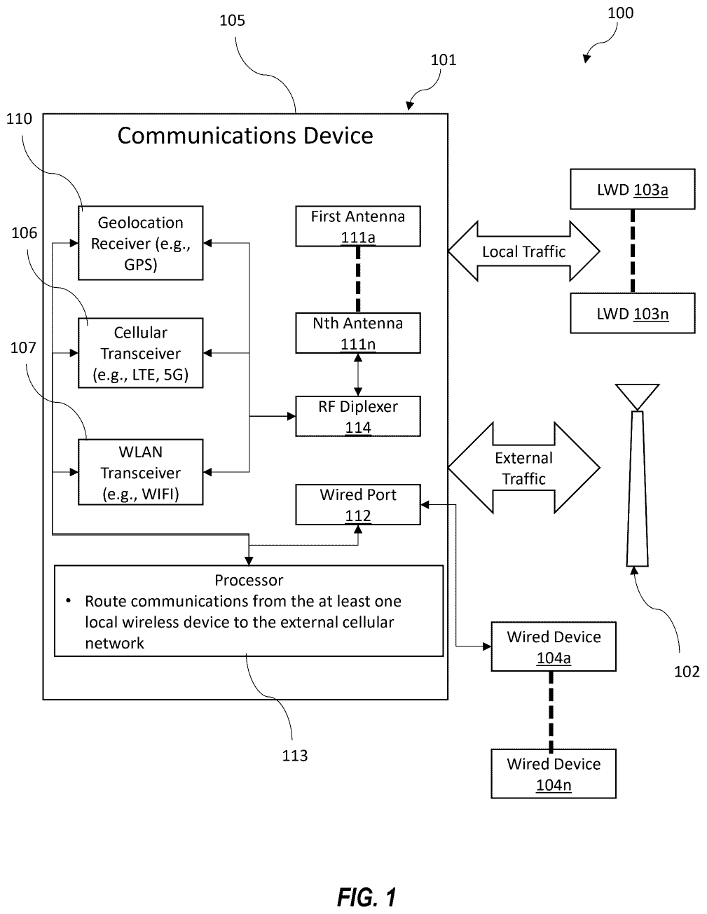

Referring now to FIG. 1, a communication system 100 according to the present disclosure is now described. The communication system 100 includes a communications device 101 (i.e., the FBT device), an external cellular network 102 (e.g., 3G-5G, LTE network), a plurality of local wireless devices (LWDs) 103a-103n (e.g., software defined radios, typical consumer mobile devices, tablet computing devices, etc.), and a plurality of wired devices 104a-104n.

The communications device 101 illustratively includes a portable housing 105. The portable housing 105 may comprise a an IP67 specification housing, which provides for a rugged and durable housing. Further, the portable housing 105 may provide an integrated scratch resistant, high heat tolerant, and salt-water resistant sealed enclosure.

The communications device 101 illustratively includes a cellular transceiver 106 (e.g., 3G-5G, LTE network) carried by the portable housing 105 and configured to connect with the external cellular network 102. In some embodiments, the cellular transceiver 106 may comprise an LTE transceiver, which supports global LTE Bands with 3G/HSPA Fallback, and Verizon Airborne LTE Operations (ALO) Bands for unmanned operations. The cellular transceiver 106 may be agnostic to Global Cellular Carriers and supports private LTE networks.

The communications device 101 illustratively includes a WLAN transceiver 107 carried by the portable housing 105 and configured to connect with the plurality of LWDs 103a-103n. In some embodiments, the WLAN transceiver 107 comprises one or more of a WiFi transceiver (i.e. 802.11x transceiver), a Bluetooth transceiver, or a WiMAX transceiver. For example, the WLAN transceiver 107 may comprise a WiFi transceiver having 2.4 GHZ 2×2 MIMO, Maximal Ratio Combining (MRC), Maximal Likelihood (ML) decoding and Low-Density Parity Check (LDPC), which may provide robust RF performance in the most constrained environments.

The communications device 101 illustratively includes a geolocation receiver 110 carried by the portable housing and configured to generate geolocation data. In some embodiments, the geolocation receiver 110 may comprise a global positioning system (GPS) receiver, for example. The geolocation receiver 110 may be a standalone GPS receiver for asset tracking report formats and timing intervals.

The communications device 101 illustratively includes a plurality of RF antennas 111a-111n coupled to the cellular transceiver 106, the WLAN transceiver 107, and the geolocation receiver 110. The communications device 101 comprises one or more wired ports 112 (illustrated as one for drawing clarity) carried by the portable housing 105, and a processor 113 carried by the portable housing and coupled to the cellular transceiver 106, the WLAN transceiver 107, the geolocation receiver 110, and the wired port 112.

The processor 113 is configured to route communications from the plurality of LWDs 103a-103n to the external cellular network 102. As will be appreciated, the processor 113 servers as a local router for the plurality of LWDs 103a-103n and the plurality of wired devices 104a-104n, exchanging local traffic, and accepting traffic for external transmission via the cellular transceiver 106.

The wired port 112 may comprise one or more ports in some embodiments for connection to one or more of the wired devices 104. For example, the wired port 112 may comprise one or more of an ODU multi-pin port, a USB port, an ethernet communications port, a serial port, or an external power port for operation or charging on-board battery (not shown). Further, the communications device 101 may have fully user configurable networking options, and the communications device may provide secure VPN servers and client capability.

The communications device 101 illustratively includes an RF diplexer 114 coupled between the plurality of RF antennas 111a-111n and the cellular transceiver 106, the WLAN transceiver 107, and the geolocation receiver 110. As will be appreciated, the RF diplexer 114 routes received and transmitted signals to the appropriate RF antenna. In some embodiments, the processor 113, the cellular transceiver 106, the WLAN transceiver 107, the geolocation receiver 110, and the wired port 112 may be provided on an application specific integrated circuit (ASIC). For example, some embodiments may use the pX2LTE-4GL, as available from MicroHard Systems Inc. of Calgary, Canada.

Another aspect is directed to a method for operating a communications device 101 comprising a portable housing 105, a cellular transceiver 106 carried by the portable housing and configured to connect with an external cellular network 102, and a WLAN transceiver 107 carried by the portable housing and configured to connect with a plurality of LWDs 103a-103n. The communications device 101 also includes a geolocation receiver 110 carried by the portable housing 105 and configured to generate geolocation data, a plurality of RF antennas 111a-111n coupled to the cellular transceiver 106, the WLAN transceiver 107, and the geolocation receiver 110, and a wired port 112 carried by the portable housing. The method comprises operating a processor 113 coupled to the cellular transceiver 106, the WLAN transceiver 107, the geolocation receiver 110, and the wired port 112. The processor 113 is configured to route communications from the plurality of LWDs 103a-103n to the external cellular network 102.

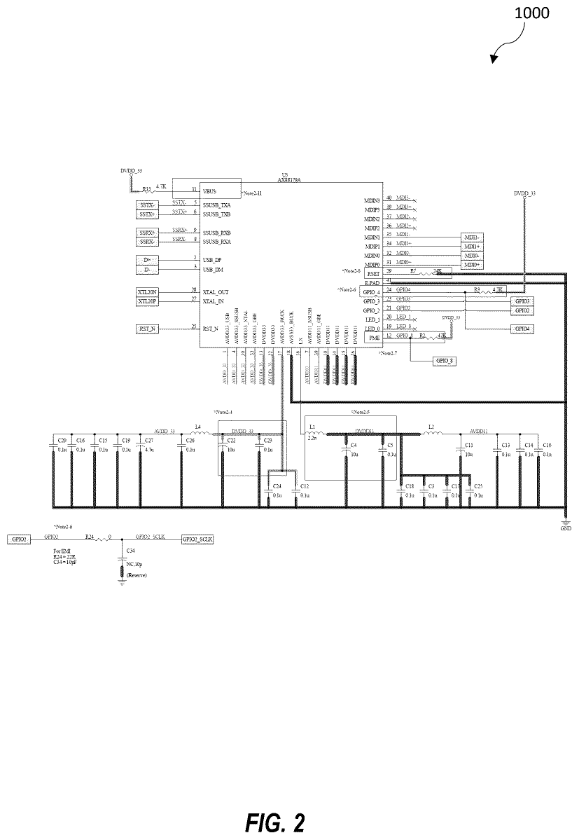

Referring now additionally to FIG. 2, an ethernet controller 1000 to be coupled to the wired port 112 is shown. For example, the ethernet controller 1000 may comprise an AX88179A controller, as available from the ASIX Electronics Corporation of Taiwan.

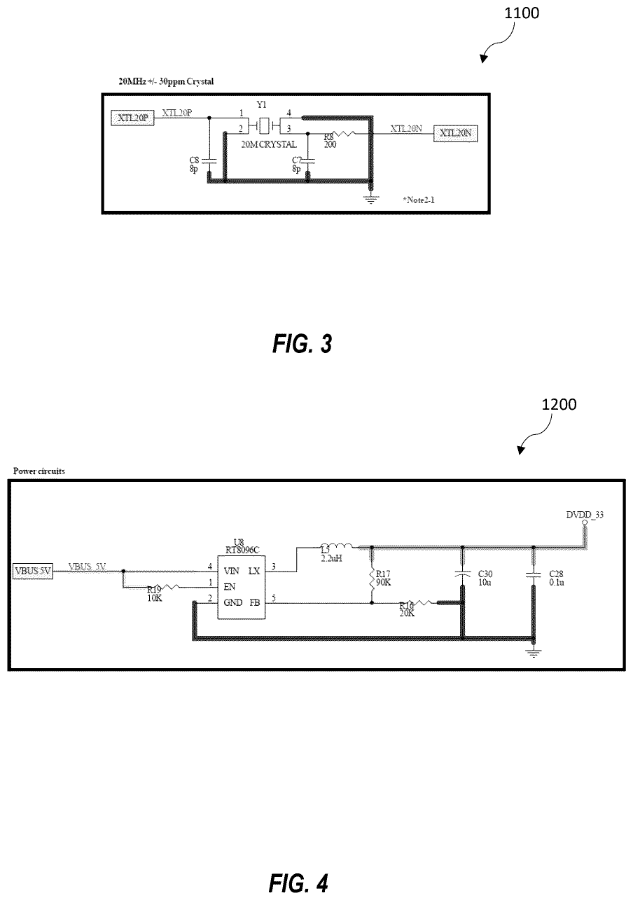

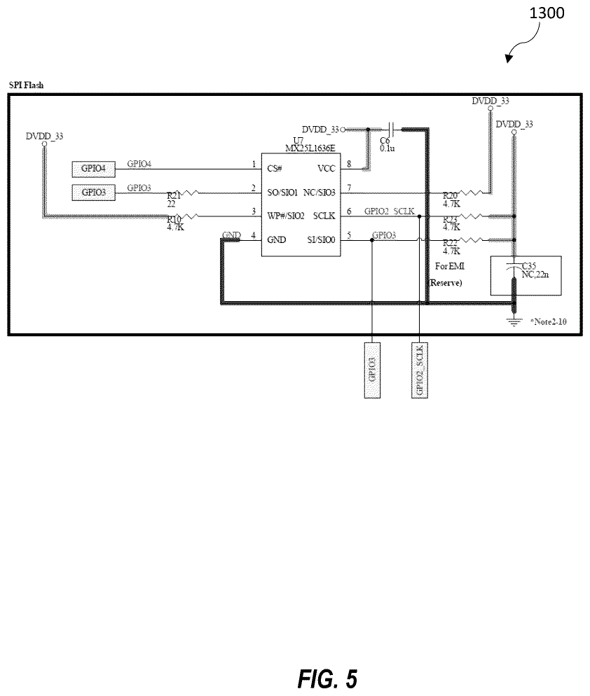

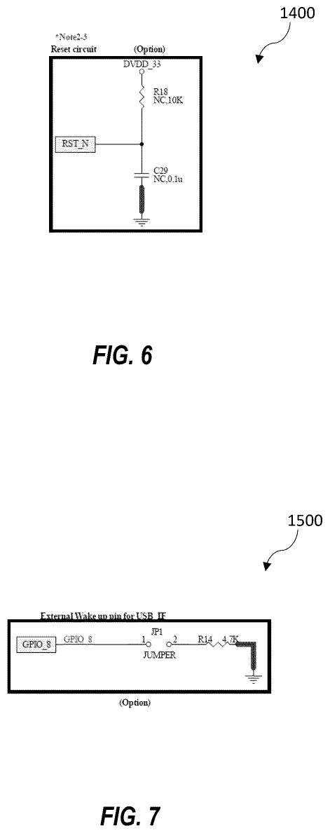

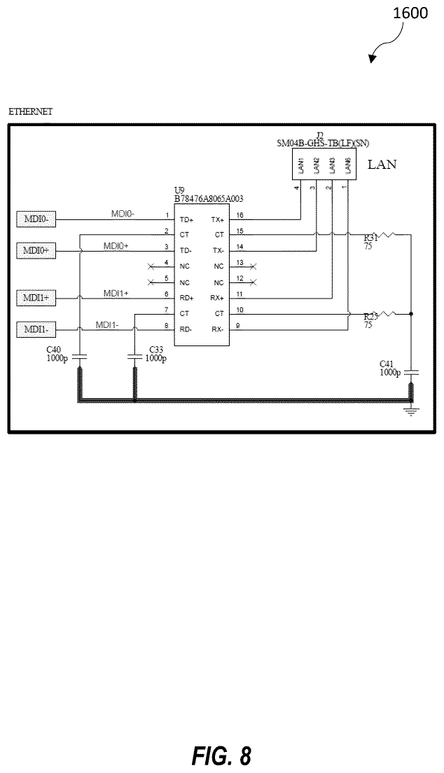

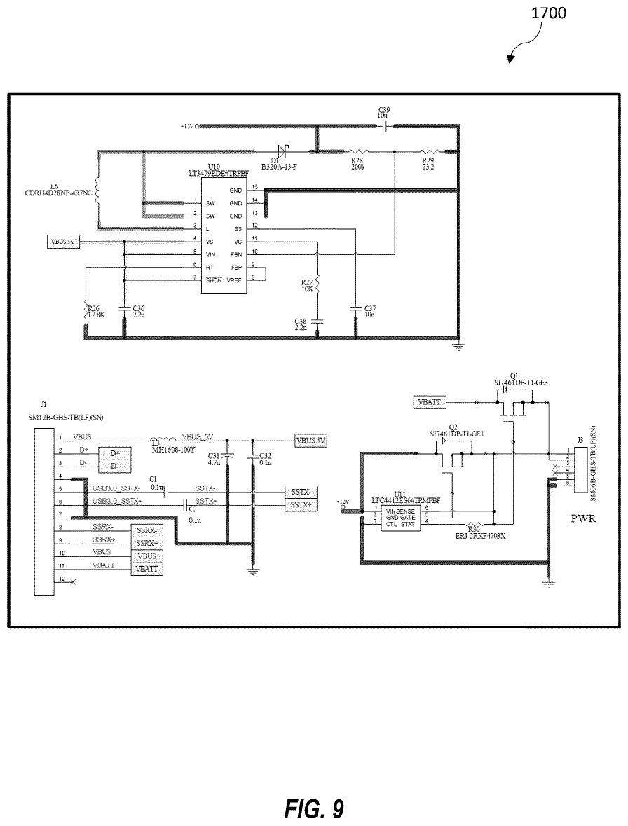

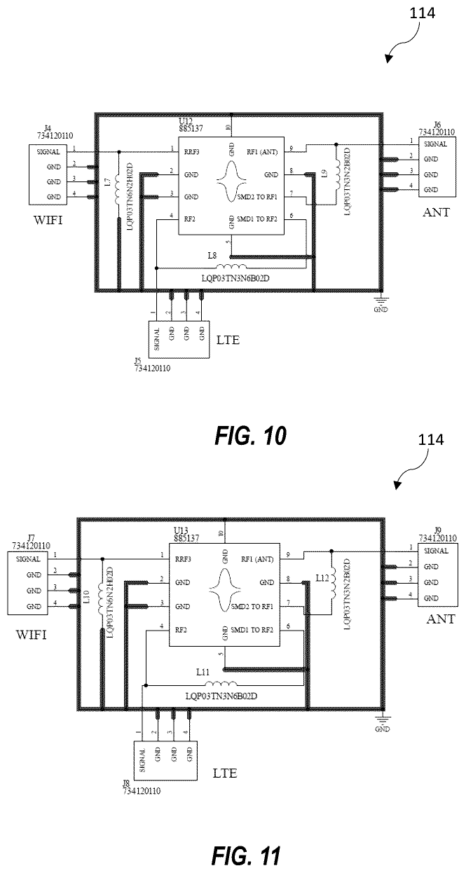

Referring now additionally to FIGS. 3-5, an oscillator circuit 1100, a power circuit 1200, and an SPI flash circuit 1300 (i.e., a memory circuit) are shown. Each of these circuits would be coupled to the processor 113. Referring now additionally to FIGS. 6-7, a reset circuit 1400 and an external wakeup circuit 1500 are shown. Each of these circuits would be coupled to the processor 113. Referring now additionally to FIGS. 8-9, an ethernet circuit 1600 and a USB/power circuit 1700 are shown. Each of these circuits would be coupled to the processor 113. Referring now additionally to FIGS. 10-11, an RF diplexer 114 is shown.

Helpfully, the communications device 101 may support multiple connection and configuration options packaged in an IP67, rugged, low power draw solution. This may provide the user with enhanced capabilities, previously requiring multiple devices, now all-in-one scratch resistant, high heat tolerant, salt-water resistant sealed enclosure.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A communications device comprising:
a portable housing;
a cellular transceiver carried by the portable housing and configured to connect with an external cellular network;
a wireless local area network (WLAN) transceiver carried by the portable housing and configured to connect with at least one local wireless device;
a geolocation receiver carried by the portable housing and configured to generate geolocation data;
a plurality of radio frequency (RF) antennas coupled to the cellular transceiver, the WLAN transceiver, and the geolocation receiver;
at least one wired port carried by the portable housing; and
a processor carried by the portable housing and coupled to the cellular transceiver, the WLAN transceiver, the geolocation receiver, and the at least one wired port, the processor configured to route communications from the at least one local wireless device to the external cellular network.

2. The communications device of claim 1 further comprising an RF diplexer coupled between the plurality of RF antennas and the cellular transceiver, the WLAN transceiver, and the geolocation receiver.

3. A method for operating a communications device comprising a portable housing, a cellular transceiver carried by the portable housing and configured to connect with an external cellular network, a wireless local area network (WLAN) transceiver carried by the portable housing and configured to connect with at least one local wireless device, a geolocation receiver carried by the portable housing and configured to generate geolocation data, a plurality of radio frequency (RF) antennas coupled to the cellular transceiver, the WLAN transceiver, and the geolocation receiver, and at least one wired port carried by the portable housing, the method comprising:
operating a processor coupled to the cellular transceiver, the WLAN transceiver, the geolocation receiver, and the at least one wired port, the processor configured to route communications from the at least one local wireless device to the external cellular network.
